(19) United States
(12) Patent Application Publication
(10) Pub. No.: US 2004/0268093 A1
(43) Pub. Date: Dec. 30, 2004

(54) Cross-thread register sharing technique

(76) Inventors: Nicholas G. Samra, Austin, TX (US); Andrew S. Huang, Austin, TX (US)

Correspondence Address: Lester J. Vincent, BLAKELY, SOKOLOFF, TAYLOR & ZAFMAN LLP, Seventh Floor, 12400 Wilshire Boulevard, Los Angeles, CA, 90025, US

(21) Appl. No.: 10/609,264

(22) Filed: Jun. 26, 2003

(51) Int. Cl. G06F 9/30

(52) U.S. Cl. 712/217

(57) ABSTRACT

A technique for sharing register resources within a microprocessor. Embodiments of the invention pertain to a register sharing technique within a microprocessor for multiple-threads of instructions that facilitates an optimal number of physical registers to be mapped to a desired number of logical registers without incurring significant hardware overhead.

### FIELD

Embodiments of the invention relate to microprocessor architecture. More particularly, embodiments of the invention relate to a technique for sharing register resources within a microprocessor.

### BACKGROUND

In typical high-performance, superscalar microprocessors, one technique to improve performance is register renaming, in which logical registers referred to by the instructions are mapped onto a larger set of physical registers. This physical register mapping helps eliminate false dependencies that would exist in the logical register mapping. Traditionally, structures such as a register alias table (RAT) would store the logical-to-physical mappings, whereas another structure, such as a freelist table (“freelist”), would hold the unused or “free” physical registers until they are allocated and used by the rename unit.

In multi-threaded processors, which have the ability to execute several threads concurrently, a technique for allocating physical registers from the freelist may use either a hard-partitioned freelist or shared one. A shared freelist technique usually requires a larger freelist table and associated logic but has a performance advantage of having all of the registers within the freelist available for one active thread if the processor is running in single-thread mode. A hard-partitioned freelist technique requires less hardware but can constrain performance because the number of registers per thread is fixed.

An example of a prior art shared register allocation technique for a two-threaded processor is illustrated in FIG. 1. When a register is allocated for either or both threads, it is read from the freelist 105 and written into the appropriate RAT 110 as a renamed register. Furthermore, a separate structure such as a Re-Order Buffer (ROB) 115 tracks allocated registers so that they can be returned to the freelist when no longer needed.

It would be difficult for the shared freelist itself to handle register de-allocation, because there is no guaranteed retirement order between the two threads. The number of entries in the freelist is equal to the number of physical registers, and at reset, the freelist is initialized with each physical register number. These initialized registers may then be allocated into the RAT of either or both threads.

The amount of hardware necessary for a particular number of physical registers may be reduced with a hard-partitioned register allocation technique. A prior art example of a hard-partitioned register allocation technique is illustrated in FIG. 2. The hard-partitioned register allocation technique of FIG. 2 assigns which registers may be used for each thread. Furthermore, if a thread is dormant, its assigned registers are unused, which wastes physical register space as well.

In the prior art example of FIG. 2, a RAT 210 and freelist 205 may be initialized with the physical register numbers, which allows each freelist to only track the registers not currently used by the RAT, thereby limiting the size of the freelist. Assuming that each thread retires instructions in program order, each freelist can handle register de-allocation without an ROB, thus reducing the need for a separate structure to perform re-allocation.

The prior art example of FIG. 1 maximizes the size of freelist that is available for a particular thread, but requires the use of extra hardware, namely the ROB, to re-allocate registers in the freelist. On the other hand, the prior art example of FIG. 2 allows registers to be re-allocated in the freelist without the use of an ROB, but reduces the number of freelist entries available to a single thread.

### BRIEF DESCRIPTION OF THE DRAWINGS

Embodiments of the invention are illustrated by way of example and not limitation in the figures of the accompanying drawings, in which like references indicate similar elements and in which:

FIG. 1 illustrates a prior art register sharing technique for a multi-threaded processor that maximizes the freelist space available for a single thread.

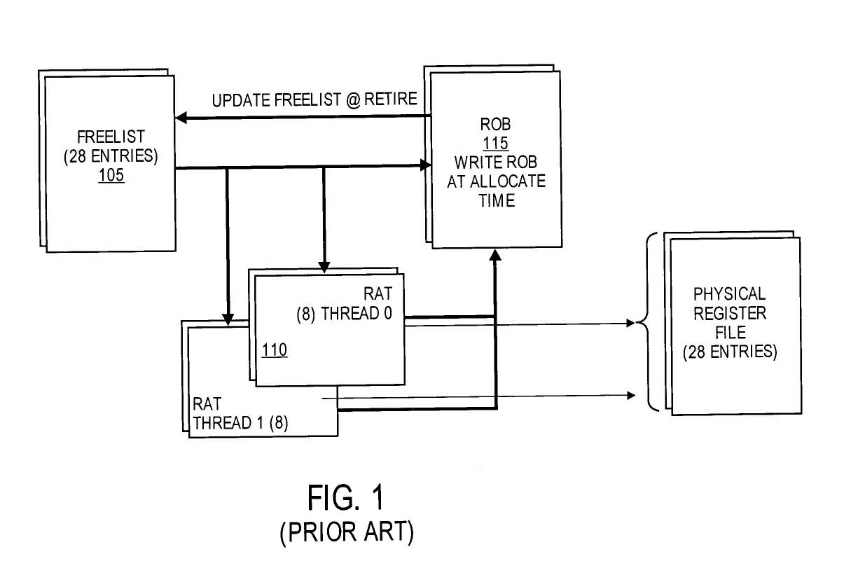

FIG. 2 illustrates a prior art register sharing technique that reduces the use of extra hardware structures to re-allocate retired instructions in the freelist.

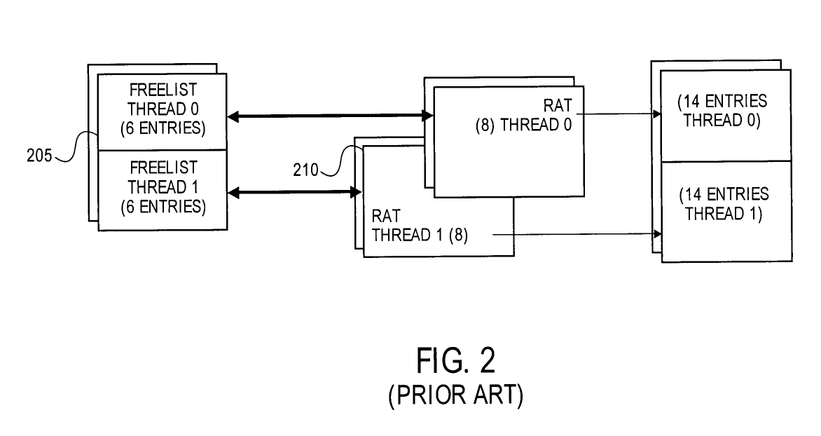

FIG. 3 illustrates computer system in which at least one embodiment of the invention may be used.

FIG. 4 illustrates a microprocessor architecture in which at least one embodiment of the invention may be used.

FIG. 5 illustrates a register sharing technique in single-thread mode according to one embodiment of the invention.

FIG. 6 illustrates a register sharing technique in multi-thread mode according to one embodiment of the invention.

FIG. 7 is a flow chart that illustrates various operation to perform.

### DETAILED DESCRIPTION

Embodiments of the invention pertain to microprocessor architecture. More particularly, embodiments of the invention pertain to a register sharing technique within a microprocessor for multiple-threads of instructions that facilitates an optimal number of physical registers to be mapped to a desired number of logical registers without incurring significant hardware overhead.

In at least one embodiment of the invention, a technique is used that incurs hardware costs associated with a hard-partitioned register sharing technique but that makes more registers available to one thread when another thread is dormant.

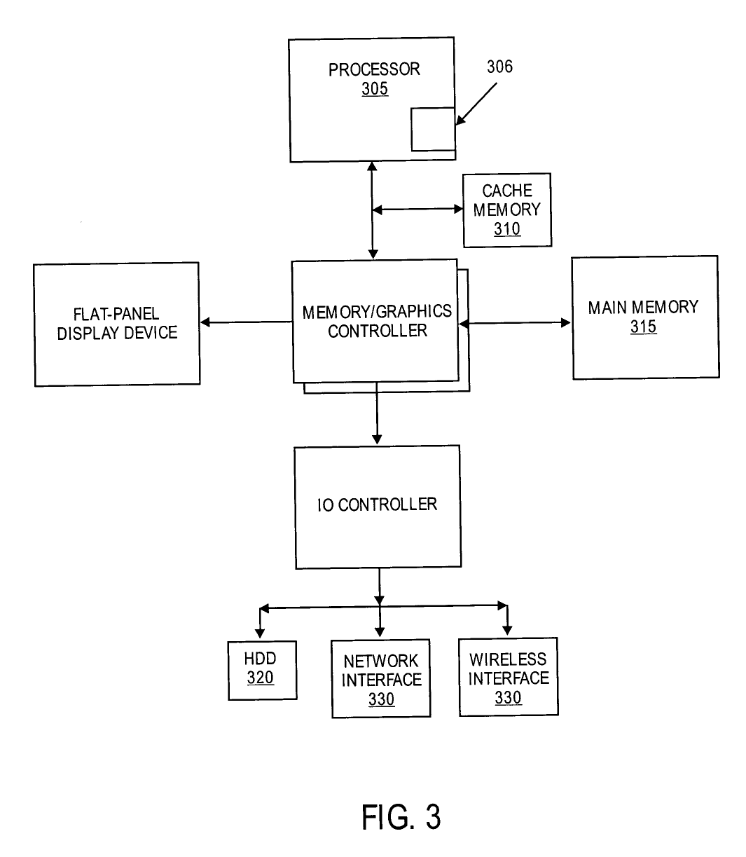

FIG. 3 illustrates a computer system in which at least one embodiment of the invention may be used. A processor 305 accesses data from a cache memory 310 and main memory 315. Illustrated within the processor of FIG. 3 is one embodiment 306 of the invention. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 320, or a memory source located remotely from the computer system via network interface 330 containing various storage devices and technologies. The cache memory may be located either within the processor or in close proximity to the processor, such as on the processor's local bus 307. Furthermore, the cache memory may contain relatively fast memory cells, such as a six-transistor (6T) cell, or other memory cell of approximately equal or faster access speed.

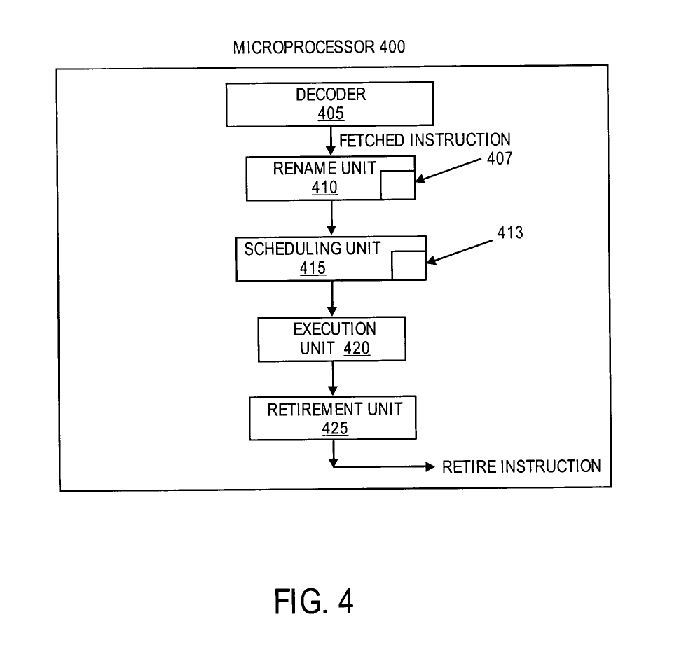

FIG. 4 illustrates a microprocessor in which at least one embodiment of the invention may be used. The processor 400 has an execution unit 420, a scheduling unit 415, rename unit 410, retirement unit 425, and decoder unit 405.

In one embodiment of the invention, the microprocessor is a pipelined, super-scalar processor that may contain multiple stages of processing functionality in a series and/or parallel configuration. Accordingly, multiple instructions may be processed concurrently within the processor, each at a different pipeline stage. Furthermore, the execution unit may be part of an execution cluster in order to process instructions of a similar type or similar attributes, such as latency-tolerance. In other embodiments, the execution unit may be a single execution unit.

The scheduling unit may contain various functional units, including embodiments of the invention 413. Other embodiments of the invention may reside elsewhere in the processor architecture of FIG. 4, including the rename unit 407.

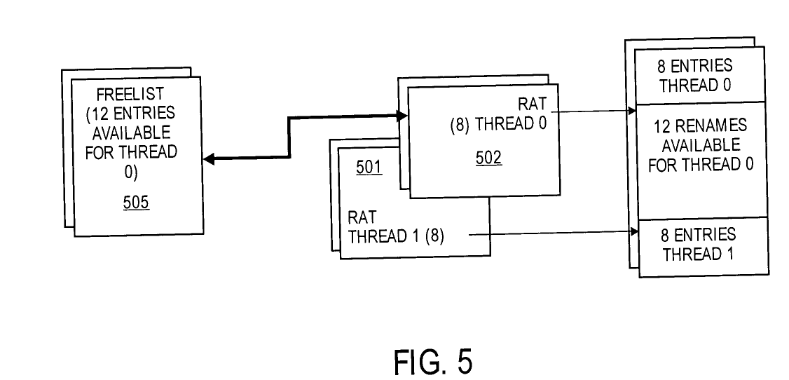

FIG. 5 illustrates a register sharing architecture according to one embodiment of the invention that facilitates an increase the number of registers available in single-thread execution mode without incurring the hardware costs of a fully shared freelist architecture. This architecture initializes both RAT's 501, 502, corresponding to thread 0 and thread 1, respectively, with register renames regardless of whether the processor is in single-thread (ST) or multi-thread (MT) mode. The freelist 505 is initialized with the remaining rename registers and checks the mode of the processor (ST or MT). If the processor is in MT mode, the freelist partitions itself so that each half of the freelist is available for a different thread. In ST mode, all registers in the freelist are available for the active thread.

In the embodiment of FIG. 5, which includes two threads, eight logical registers per thread, and twenty-eight total physical registers 510, the initial state of the machine when in ST mode is also indicated. Particularly, the last eight entries of the physical register space are used for thread 1 (currently dormant), while the first twenty entries are available for thread 0.

If the processor switches from ST to MT mode, then the freelist partitions itself in half, with each half being used for a different thread. This is similar to the prior art hard-partitioned register sharing technique, the key difference being that the set of physical registers allotted to each thread will be dependent on the state of the freelist at the time of the ST-to-MT transition, rather than a predetermined set of physical registers per thread. This means that registers used by each thread in the physical register file will be dispersed randomly throughout the physical register file.

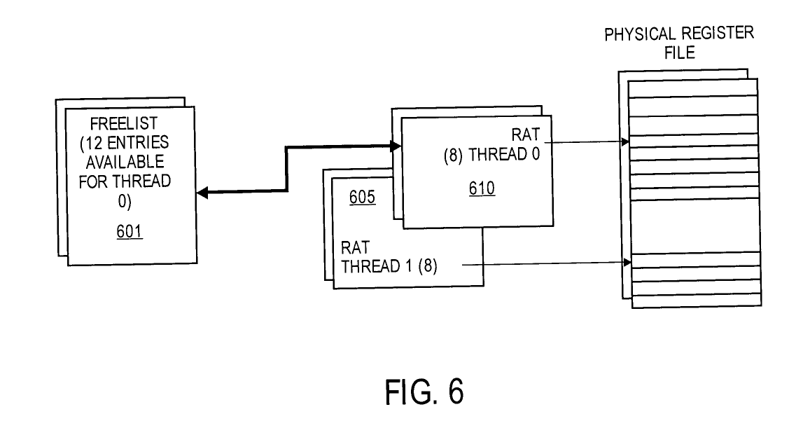

FIG. 6 illustrates the state of the architecture after an MT to ST transition according to one embodiment of the invention. Particularly, in an MT to ST transition, the freelist 601 un-partitions itself and allows registers remaining in the freelist at that time to be allocated by the active thread. The dormant thread 605 will still have eight registers allocated in the physical register file in random positions (and unusable by the active thread). The active thread 610 will again have twenty physical registers with which to map the eight logical registers.

Various aspects of embodiments of the invention may be implemented using complementary metal-oxide-semiconductor (CMOS) circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software.

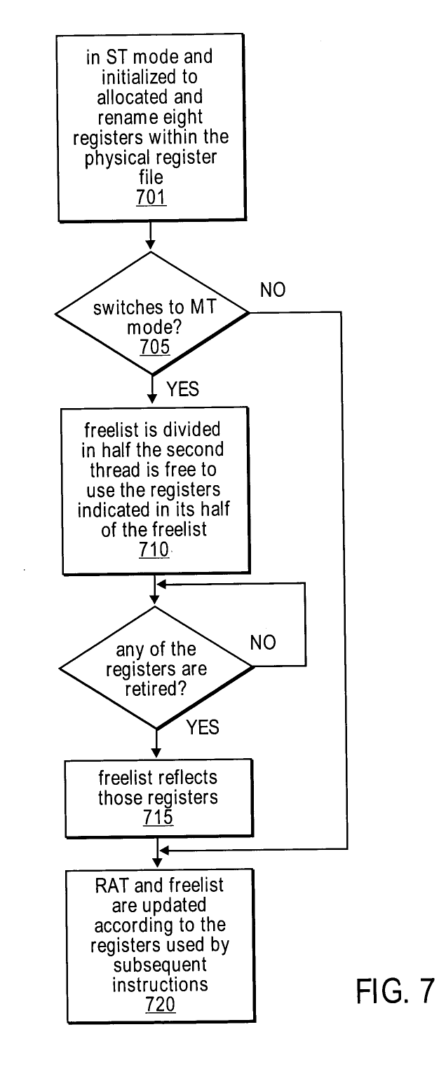

FIG. 7 is a flow chart that illustrates various operations to perform at least one embodiment of the invention. At operation 701, the embodiment of the invention is in ST mode and initialized to allocate and rename eight registers within the physical register file. Furthermore, twelve more unused registers in the physical register file are listed in the freelist, to be used by the active thread. If the processor in which the embodiment of the invention of FIG. 7 is performing switches to MT mode at operation 705, the freelist is divided in half at operation 710 and the second thread is free to use the registers indicated in its half of the freelist. If any of the registers are retired, the freelist reflects those registers at operation 715 accordingly, whether in MT or ST mode. If the embodiment of the invention illustrated in FIG. 7 does not switch between MT and ST modes, the RAT and freelist are updated according to the registers used by subsequent instructions at operation 720.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. An apparatus comprising:
a physical register file in which data associated with instructions of a computer program are stored in an order that is independent of whether a processor executing the instructions is in a multithread (MT) mode or a single-thread (ST) mode.

2. The apparatus of claim 1 further comprising at least one register allocation table (RAT) to indicate allocation of the data from logical registers to physical registers within the physical register file.

3. The apparatus of claim 1 further comprising a list of physical registers within the physical register file that are not allocated to a logical register, entries in the list being completely allocated to a first thread while the processor is in ST mode and entries in the list being partitioned such that a first portion of the entries are allocated to a first thread and a second portion of the entries are allocated to a second thread while the processor is in MT mode.

4. The apparatus of claim 3 wherein a first portion of all of the physical registers in the physical register file are allocated to the first thread and a second portion of all of the physical registers in the physical register file are allocated to the second thread if the processor is in ST mode, the first portion of all of the physical registers being larger than the second portion of all of the physical registers.

5. The apparatus of claim 4 wherein the second thread is dormant if the processor is in ST mode.

6. The apparatus of claim 4 wherein the first portion of all of the physical registers within the physical register file remain allocated to the first thread after the processor transitions to MT mode until instructions associated with data within the first portion of all of the physical registers within the physical register file are retired.

7. The apparatus of claim 6 wherein the physical registers associated with the retired instructions are indicated within the list of physical registers.

8. An apparatus comprising:
first means for indicating registers within a physical register file for use by a microprocessor that are not allocated to logical registers, the first means being partitioned during a second mode of operation of the microprocessor and not being partitioned during a first mode of operation of the microprocessor;
second means for allocating the logical registers to the physical registers.

9. The apparatus of claim 8 wherein the logical registers are allocated to the physical registers independently of the relative position of the logical registers to each other.

10. The apparatus of claim 9 wherein the second means comprises a register allocation table to indicate the allocation of the logical registers to the physical registers.

11. The apparatus of claim 9 wherein the second means comprises a plurality of register allocation tables to indicate the allocation of the logical registers to the physical registers, each of the plurality of register allocation tables being associated with a separate thread of instructions.

12. The apparatus of claim 11 wherein the first mode of operation is a single thread mode and the second mode is a multiple-thread mode.

13. The apparatus of claim 12 wherein the first means is a register file comprising a list of the physical registers that are not allocated to the logical registers.

14. The apparatus of claim 13 wherein the sum of the number of physical registers in the list and the number of logical registers associated with a single thread equals the number of physical registers within the physical register file.

15. The apparatus of claim 14 wherein a first physical register is indicated in the list after an instruction associated with data stored in the first physical register is retired.

16. A system comprising:
a memory unit to store a first and second thread of instructions;
a processor to perform the first and second thread of instructions, the processor comprising a physical register file wherein data corresponding to the first and second thread of instructions are stored in an order independent of whether the processor is in a multithread (MT) mode or a single-thread (ST) mode.

17. The system of claim 16 wherein the processor further comprises at least one register allocation table (RAT) to indicate allocation of the data from logical registers to physical registers within the physical register file.

18. The system of claim 16 further comprising a list of physical registers not allocated to a logical register, entries in the list being completely allocated to the first thread while the processor is in ST mode and entries in the list being partitioned such that a first portion of the entries are allocated to the first thread and a second portion of the entries are allocated to the second thread while the processor is in MT mode.

19. The system of claim 18 wherein a first portion of all of the physical registers in the physical register file are allocated to the first thread and a second portion of all of the physical registers in the physical register file are allocated to the second thread if the processor is in ST mode, the first portion of all of the physical registers being larger than the second portion of all of the physical registers.

20. The system of claim 19 wherein the second thread is dormant if the processor is in ST mode.

21. The system of claim 19 wherein the first portion of all of the physical registers within the physical register file remain allocated to the first thread after the processor transitions to MT mode until instructions associated with data within the first portion of all of the physical registers within the physical register file are retired.

22. The system of claim 21 wherein the physical registers associated with the retired instructions are indicated within the list of physical registers.

23. A method comprising:
initializing a register allocation table (RAT) to map a first group of logical registers to a second group of physical registers;
dividing a freelist of registers in half if a processor associated with the free list is in multi-thread (MT) mode;
undividing the freelist of registers if the processor is in single-thread (ST) mode.

24. The method of claim 23 further comprising transitioning from ST mode to MT mode, the second group of physical registers being interspersed throughout a physical register file.

25. The method of claim 24 wherein the second group of physical registers remain interspersed throughout the physical register file after the transition from ST to MT mode.

26. The method of claim 23 further comprising transitioning from MT mode to ST mode, the second group of physical registers being interspersed throughout a physical register file.

27. The method of claim 26 wherein the second group of physical registers remain interspersed throughout the physical register file after the transition from MT to ST mode.

28. The method of 23 wherein the logical registers are allocated to the physical registers independently of the relative position of the logical registers to each other.

29. The method of claim 28 wherein the sum of the entries in the freelist and the number of logical registers associated with a single thread equals the number of physical registers within the physical register file.

30. The method of claim 29 further comprising a indicating a first physical register in the freelist after an instruction associated with data stored in the first physical register is retired.
